(19) United States
(12) Patent Application Publication
(10) Pub. No.: US 2003/0189592 A1
(43) Pub. Date: Oct. 9, 2003

(54) Systems and methods for providing self-governing online communities

(76) Inventor: Dan Peter Boresjo, Berkshire (GB)

Correspondence Address: HARRITY & SNYDER, LLP, 11240 WAPLES MILL ROAD, SUITE 300, FAIRFAX, VA, 22030, US

(21) Appl. No.: 10/116,046

(22) Filed: Apr. 5, 2002

(51) Int. Cl. G09G 5/00

(52) U.S. Cl. 345/751

(57) ABSTRACT

A method for establishing a business entity by an online forum may include proposing to form a business entity. A proposal associated with forming the business entity may be reviewed within the online forum. Members of the online forum may vote on the proposal. The business entity may be established if a sufficient number of members of the online forum vote for the proposal. The resulting business entity may be controlled by the online forum.

### BACKGROUND OF THE INVENTION

1. Field of the Invention

The present invention relates generally to client-server networks and, more particularly, to online communities implemented on such networks.

2. Description of Related Art

Today, many individuals from around the world use the Internet to share information, views, and otherwise interact. Individuals may meet in “online forums,” which as used herein, may be defined as any online discussion group or community in which participants may exchange (generally open) messages. Examples of such online forums may include chat rooms, message boards, and web pages (e.g., slashdot.org).

Online forums may be organized based on, for example, shared interests of their members. These members with shared interests may wish to collectively act to further their interests. Such collective action of an online forum, however, may be hampered by the members' inability to, for example, own property in common or enter into contracts as a collective entity.

As a result, there exists a need for mechanisms which facilitate collective action by online forums.

### SUMMARY OF THE INVENTION

Systems and methods consistent with the present invention address this and other needs through facilitating the establishment of a business entity or financial instrument to be controlled by an online forum. Members of the online forum may discuss and vote on a proposal to form the business entity.

In accordance with one aspect of the invention as embodied and broadly described herein, a method for establishing a business entity by an online forum may include proposing to form a business entity and reviewing, within the online forum, a proposal associated with forming the business entity. The method may also include voting on the proposal by members of the online forum. The business entity may be established if a sufficient number of members of the online forum vote for the proposal.

In accordance with another implementation consistent with the present invention, a method for facilitating collective action by an online forum may include aiding in creation of the online forum and assisting in establishment of an external instrumentality to be controlled by the online forum. The method may also include hosting the online forum and facilitating determination of a collective will of the online forum.

In accordance with a further implementation consistent with the present invention, a method for facilitating collective action by an online forum may include storing a machine-executable command proposed by a member of the online forum. Votes of members of the online forum regarding the machine-executable command may be counted. Execution of the machine-executable command may be facilitated when a threshold number of votes in favor of the machine-executable command are counted.

In accordance with yet another implementation consistent with the present invention, a method for collective action by an online forum may include proposing execution of a machine-executable command to the online forum by a member of the online forum. Members of the online forum may vote whether to execute the machine-executable command. The machine-executable command may be transmitted for execution in response to the voting and based on predetermined voting criteria.

In accordance with still a further implementation consistent with the present invention, a computer-readable medium that stores instructions executable by one or more processors to perform a method for facilitating collective action be an online forum may include instructions for creating a new online forum in response to a request and instructions for setting up a business entity in an appropriate jurisdiction with articles specifying that the business entity will be controlled by the online forum. The medium may also include instructions for storing proposals for action by the online forum. At least one proposal may be for setting up the business entity. The medium may include instructions for establishing voting procedures by the online forum on the proposal for setting up the business entity.

### BRIEF DESCRIPTION OF THE DRAWINGS

The accompanying drawings, which are incorporated in and constitute a part of this specification, illustrate an embodiment of the invention and, together with the description, explain the invention. In the drawings,

FIG. 1 is a diagram of an exemplary network in which systems and methods consistent with the present invention may be implemented;

FIG. 2 is an exemplary diagram of a server of FIG. 1 in an implementation consistent with the present invention;

FIG. 3 is an exemplary diagram illustrating a general process of collective action by an online forum according to an implementation consistent with the present invention;

FIG. 4 is a flowchart illustrating a process of forming a business entity by an online forum according to an implementation consistent with the present invention;

FIG. 5 is a flowchart illustrating an exemplary process for admitting members in the process of FIG. 4;

FIG. 6 is a flowchart illustrating an exemplary process for voting in the process of FIG. 4;

FIG. 7 is a flowchart illustrating an exemplary process for establishing a new business entity in the process of FIG. 4;

FIG. 8 is a flowchart illustrating an exemplary process for conducting entity business in the process of FIG. 4; and

FIG. 9 is a flowchart illustrating an exemplary process for facilitating collective action of an online forum.

### DETAILED DESCRIPTION

The following detailed description of the invention refers to the accompanying drawings. The same reference numbers in different drawings may identify the same or similar elements. Also, the following detailed description does not limit the invention. Instead, the scope of the invention is defined by the appended claims and equivalents.

Systems and methods consistent with the present invention may facilitate the establishment of a business entity or financial instrument to be controlled by an online forum. Members of the online forum may discuss and vote on a proposal to form the business entity, which may be automatically established upon passage of the proposal.

### EXEMPLARY NETWORK

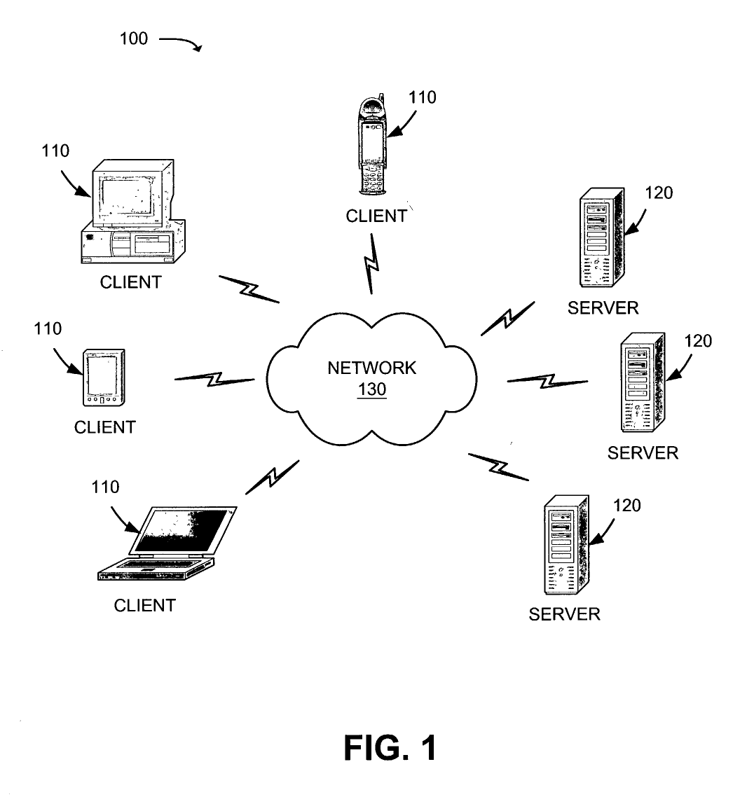

FIG. 1 is an exemplary diagram of a network 100 in which systems and methods consistent with the present invention may be implemented. The network 100 may include multiple clients 110 connected to multiple servers 120 via a network 130. The network 130 may include a local area network (LAN), a wide area network (WAN), a telephone network, such as the Public Switched Telephone Network (PSTN), an intranet, the Internet, a similar or dissimilar network, or a combination of networks. Four clients 110 and three servers 120 have been illustrated as connected to network 130 in FIG. 1 for simplicity of explanation. In practice, there may be more or less clients 110 and servers 120. Further, the clients 110 and servers 120 may function as full peers in, for example, a distributed system, and the network 100 should not be limited by the convenient use of the terms “client” and “server.”

The clients 1 10 may include devices, such as wireless telephones, personal computers, personal digital assistants (PDAs), notebook computers, etc., threads or processes running on these devices, and/or objects executable by these devices. The servers 120 may include server devices, threads, and/or objects that operate or maintain web sites in a manner consistent with the present invention. The clients 110 and servers 120 may connect to the network 130 via wired, wireless, or optical connections.

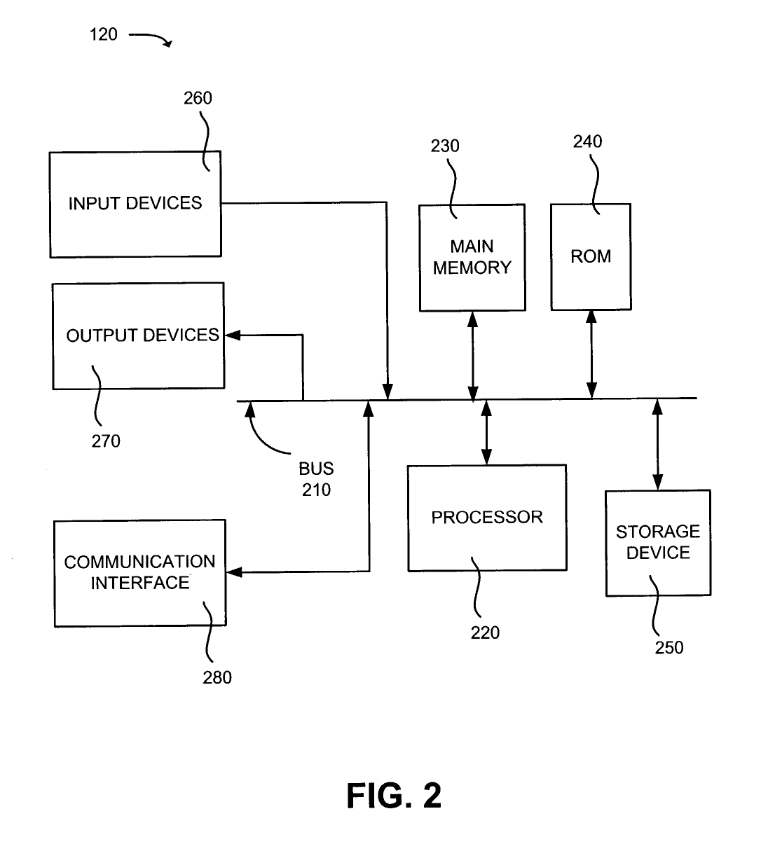

FIG. 2 is an exemplary diagram of a server 120 in an implementation consistent with the present invention. The server 120 may include a bus 210, a processor 220, a main memory 230, a read only memory (ROM) 240, a storage device 250, one or more input devices 260, one or more output devices 270, and a communication interface 280. The bus 210 may include one or more conductors that permit communication among the components of the server 120.

The processor 220 may include any type of conventional processor or microprocessor that interprets and executes instructions. The main memory 230 may include a random access memory (RAM) or another dynamic storage device that stores information and instructions for execution by the processor 220. The ROM 240 may include a conventional ROM device or another type of static storage device that stores static information and instructions for use by the processor 220. The storage device 250 may include a magnetic and/or optical recording medium and its corresponding drive.

The input devices 260 may include one or more conventional mechanisms that permit an operator to input information to the server 120, such as a keyboard, a mouse, a pen, voice recognition and/or biometric mechanisms, etc. The output devices 270 may include one or more conventional mechanisms that output information to the operator, including a display, a printer, a speaker, etc. The communication interface 280 may include any transceiver-like mechanism (e.g., a network interface card) that enables the server 120 to communicate with other devices and/or systems. For example, the communication interface 280 may include mechanisms for communicating with another device or system via a network, such as network 130.

As will be described in detail below, a server 120, consistent with the present invention, may facilitate the establishment of a business-related or financial instrumentality under control of an online forum. The server 120 may perform this task in response to processor 220 executing software instructions contained in a computer-readable medium, such as memory 230. A computer-readable medium may be defined as one or more memory devices and/or carrier waves.

The software instructions may be read into memory 230 from another computer-readable medium, such as the data storage device 250, or from another device via the communication interface 280. The software instructions contained in memory 230 cause processor 220 to perform processes that will be described later. Alternatively, hardwired circuitry may be used in place of, or in combination with, software instructions to implement processes consistent with the present invention. Thus, the present invention is not limited to any specific combination of hardware circuitry and software.

### EXEMPLARY COLLECTIVE ACTION BY ONLINE FORUM

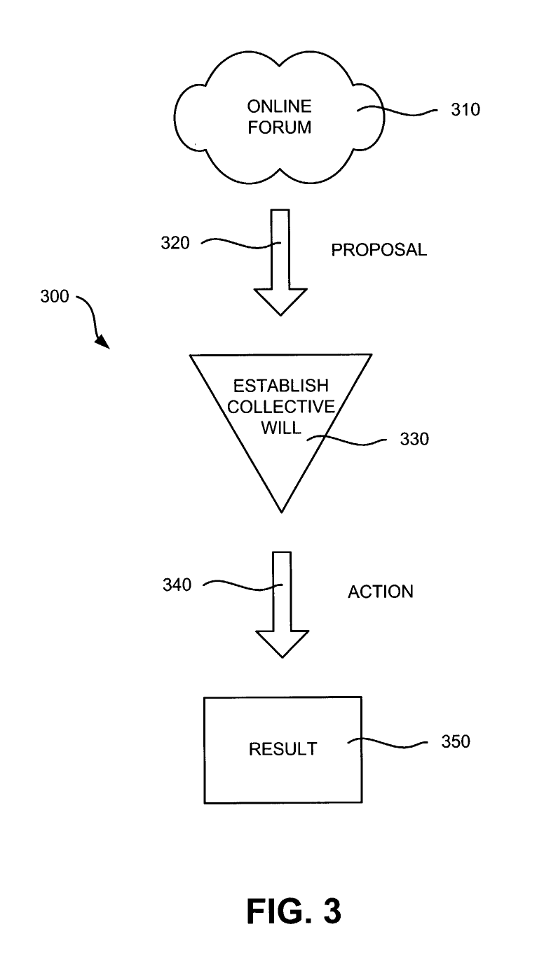

FIG. 3 is an exemplary diagram illustrating a general process 300 of collective action by an existing online forum 310 according to an implementation consistent with the present invention. The online forum 310 may be hosted by, for example, one or more servers 120. The online forum 310 may be implemented via software or a computer program that facilitates discussions and other features that will be described below.

The online forum 310 may be structured so that a member may present a proposal 320. In one implementation consistent with the principles of the invention, the proposal 320 may include a call for specific action 340 by the forum 310. In other implementations, the proposal 320 may include an issue on which the member wishes to establish a consensus within the forum 310. In each case, the proposal 320 may specify details, such as any proposal-specific variations to any “default rules” that are typically used for processing proposals.

The online forum 310 may utilize various schemes to determine its collective will 330 relating to the proposal 320. Traditional polling methods may be used, as well as different voting schemes described below. Once a threshold is reached, for example 50% of members (although other thresholds may be used), the collective will of the forum 310 may be deemed to be established 330.

If the collective will is to proceed with the proposal 320, the online forum 310 may take some action 340 as a result of the proposal 320. In one implementation consistent with the principles of the invention, the action 340 may be automatically taken upon determination of the collective will 330. In other implementations, the action 340 may be in the form of instructions to a third party to perform a task. In other implementations consistent with the principles of the invention, the action 340 may be to inform the online forum 310 of the determination of the collective will 330. For example, if voting was used to determine the collective will of the online forum 310, the action 340 may be to inform members of the forum of the voting tally.

The result 350 of the proposal 320 may follow naturally from the action 340. In one implementation consistent with the principles of the invention, the result 350 of the action 340 may be that the online forum 310 interacts in some way with the larger world (i.e., by performing a financial or legal action 340). In another implementation, if the action 340 was to inform members of the forum of the voting tally, the result 350 may be that the members of the online forum 310 may be more informed.

FIG. 3 illustrates a general process 300 of collective action by an existing online forum 310. Specific examples of this process 300 will be described in greater detail below. Although certain acts will be associated with each example, it will be apparent to those skilled in the art that particular acts may be interchanged, or not performed at all, in accordance with any given proposal 320.

### EXEMPLARY PROCESS OF FORMING BUSINESS ENTITY BY ONLINE FORUM

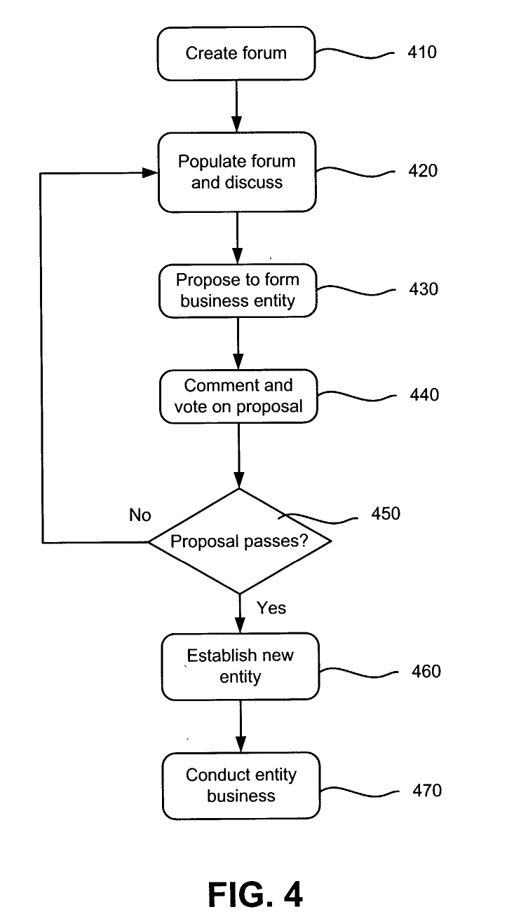

FIG. 4 is a flowchart illustrating a process of forming a business entity by an online forum 310 according to an implementation consistent with the present invention. The online forum 310 first may be created [act 410]. The forum 310 may be initiated by a person, another forum, a business entity, etc., and it may have associated characteristics. These characteristics may include, for example, a statement of purpose, admission criteria, a frequently asked questions (FAQ) document, designation of forum administrators and their powers, and so on. A computer program located on the server 120 that will host the forum 310 may facilitate creation of the forum 310.

Once created, the online forum 310 may be populated with members [act 420]. Members of the forum 310 may be admitted according to an admission criteria specified, for example, when the forum was created. As members are admitted, they may conduct online discussions of various issues.

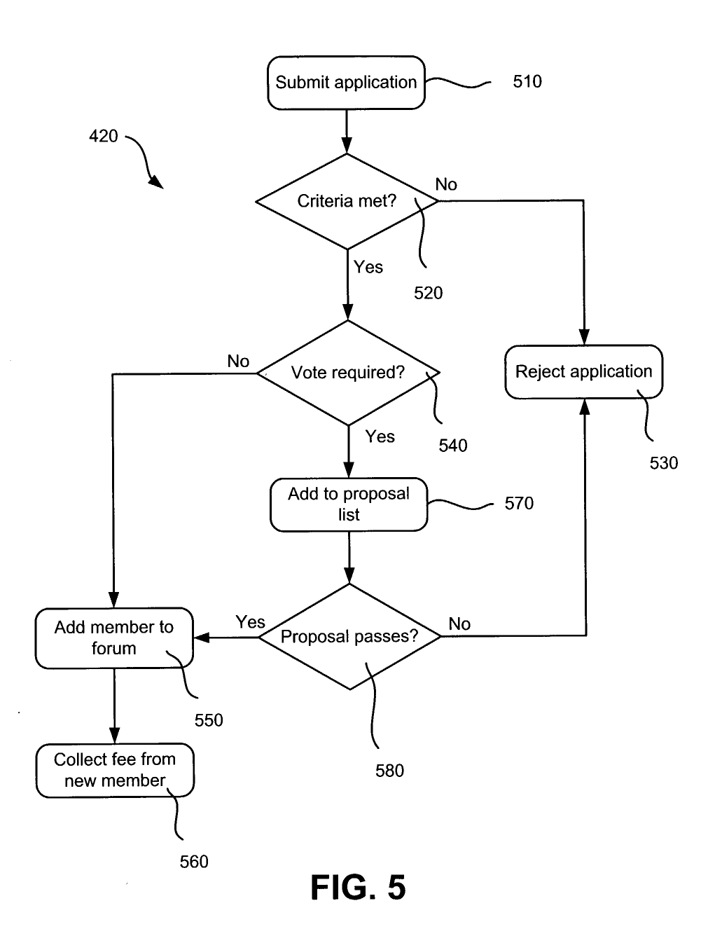

FIG. 5 is a flowchart illustrating an exemplary process for admitting members (e.g., as part of act 420) in an implementation consistent with the principles of the invention. A prospective member may submit an application including his associated information [act 510]. The application may include a form that is generated by a computer program associated with the online forum 310. The computer program, or another agency such as a forum administrator, may determine whether the application submitted by the prospective member meets certain membership criteria of the online forum 310 [act 520].

If the application does not meet the criteria for membership in the online forum 310, the prospective member's application is rejected [act 530]. In such an instance, the forum 310 may automatically generate an e-mail or other message to the prospective member notifying him of the rejection.

If the application does meet the initial criteria for membership, the forum 310 may determine whether a vote is required for admission of the prospective member [act 540]. In some instances, for example, if the prospective member is invited to join the forum 310, a vote may not be required. In such cases, the prospective member may be added to the forum 310 [act 550].

If a vote is required for membership, however, a proposal for the prospective member to join may be added to the list of proposals for consideration by the forum 310 [act 570]. The proposal may be evaluated by whatever procedure the forum 310 uses for new members [act 580], and if the proposal does not pass, the application for membership is rejected [act 530].

If the proposal passes, the prospective member may be added to the forum 310 [act 550]. Optionally, when a new member is added a fee may be collected from the new member [act 560]. In another implementation, a prospective member may include such a fee as part of his application in act 510.

At various points in FIG. 5, a member may need to provide proof of his identity. Various levels of identification may be used, ranging from mere provision of a valid e-mail address, to provision of a name/address/other details (e.g., a credit card number), to provision of personal details (e.g., name and address) that are verified by a trusted third party (e.g., a notary, solicitor, etc.). Those skilled in the art will appreciate that encrypted communication (e.g., public-key encryption) may be used to ensure the security and integrity of this identification process. Such identification may be used to ensure that, for example, the member is a paying subscriber to the forum, or that the member is a shareholder in a business entity governed by the online forum.

Returning to FIG. 4, any of the forum's members may propose to form a business entity [act 430]. As used herein, a “business entity” may include any legally recognized entity in a particular jurisdiction. The purpose/goal of a business entity need not be profit or “business” per se, but rather any common aim or goal. For example, “business entities,” as used herein, may include, but are not limited to, corporations, companies, partnerships, associations, non-profit entities, limited liability entities, clubs, unions, agencies, syndicates, cartels, joint ventures, governmental agencies, and other organizations. In one implementation, the proposing member may fill out a form specifying, for example, the type of business entity to be formed and the jurisdiction (e.g., the particular state or country) under whose laws the business entity will be formed. In another implementation, assuming that members of a forum have authority to create a governmental agency (or sub-agency), the form may specify the organizational orientation of the new governmental agency and, for example, a rule or law under which the agency may be created.

The proposal may also specify whether holdings in the business entity by the forum members are to be “equality” holdings or “equity” holdings. If equality holdings are desired, all members of the proposed business entity may hold equal shares, for example, by payment of a fixed fee. If equity holdings are desired, by contrast, all members of the proposed business entity may specify, for example during voting, the amount of money that they wish to invest in the proposed business entity.

In another implementation consistent with the principles of the invention, the creator of the forum 310 may specify a desired type and organization of a business entity when the online forum is created [act 410].

Once the proposal to form a business entity has been submitted, members may discuss, amend, and vote on the proposal [act 440]. Comments on the proposal may include text, hyperlinks, and/or attachments. In one implementation, amendments to the proposal may include a number of elements. For example, one element may specify the desired operation (e.g., add, delete, insert, replace, etc.), and another element may reference the portion of the proposal sought to be amended and a document fragment, if applicable, to be inserted.

In one implementation consistent with the principles of the invention, proposals may be stored using extensible markup language (XML). Reference to portions of such proposals may be made using XPath notation, as will be appreciated by those skilled in the art. Amendments may be displayed for viewing by members using an extensible stylesheet language transformation (XSLT) to transform the amendments to a suitable format that is viewable by the member (e.g., via a web browser). Those skilled in the art will appreciate that numerous schemes are available for submitting and viewing amendments to proposals, for example Java applets, downloadable applications, etc.

When viewing an amendment, other members may, for example, choose between viewing a summary of the amendment, or viewing the complete proposal as it would be amended by the amendment.

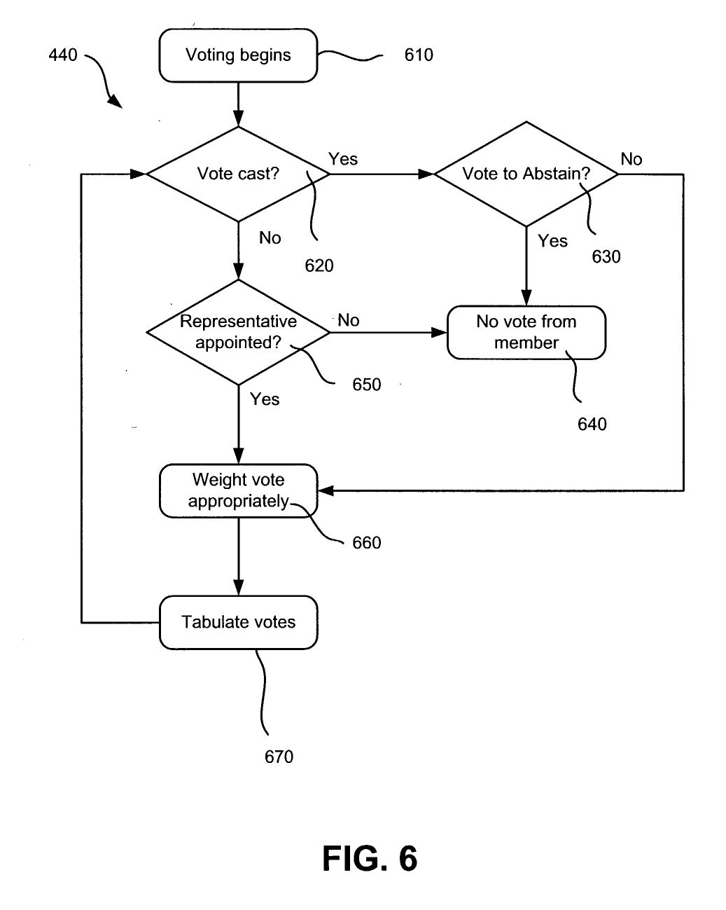

FIG. 6 is a flowchart illustrating an exemplary process for voting (e.g., as part of act 440) in an implementation consistent with the principles of the invention. Voting may begin with the inclusion of a particular proposal on a list of proposals [act 610]. Such a proposal may have an associated time limit, e.g., when the proposal will fail if a necessary voting threshold has not been reached. Votes may be tabulated (i.e., counted/weighed/calculated) continuously, or upon a new vote by a member of the forum 310. The remainder of FIG. 6 concentrates on the vote of a single member. Those skilled in the art will appreciate ways in which such a voting scheme may be accomplished for a large number of members.

At any given time a member may have affirmatively cast a vote, or not [act 620]. If a vote was cast, the program tabulating the results (“voting program”) may check whether the vote was to abstain [act 630]. An “abstain” vote may represent an affirmative desire by the member to not utilize his vote on a particular proposal. In such a case, the votes available from the member will not be counted for a given proposal [act 640].

Alternatively, if a non-abstaining vote was cast, the member's vote may be weighted if appropriate [act 660]. If the default voting scheme is “equality,” each member's vote weighs equally, and act 660 need not be performed. However, other voting schemes may exist, for example, “subscription level” voting, where a member's vote is weighted in proportion to an amount of subscription fee paid for membership in the forum 310. After a business entity is formed, “equity” voting may be used, where votes are weighted in proportion to an ownership share in the business entity governed by the forum 310. Other ways of weighting votes will be apparent to those skilled in the art.

After any vote weighting, the member's vote may be tabulated (e.g., recorded), and a vote total may be updated [act 670]. Such tabulating may be performed automatically by a voting program. The vote total may be expressed as an absolute number (e.g., X out of Y possible votes) and/or as a percentage (e.g., Z %), or in other ways. The vote total may be displayed, for example, with the proposal in the proposal list. The vote total also may be used to arrange the order of proposals within the proposal list. For example, more popular proposals (i.e., those with more total votes or affirmative votes) may be placed at the top of the proposal list to increase the likelihood that these proposals will be considered by all members.

In one implementation consistent with the present invention, a member may cast one or more alternative votes. For example, a first choice might be for proposal A, and a second choice might be for a modified version of the proposal, A*. Third and subsequent preferences may also be expressed. A number of known methods are available to determine a winner among several options, including a Condorcet method, a Borda system, etc. For binary ballots (i.e., where multiple choices are not allowed), a straight poll may determine the fate of a given proposal.

The line from act 670 to act 620 may reflect a situation in which a member has appointed a representative, but has not yet cast a vote. In such case, the representative may vote for the member and the member's vote tabulated as described with respect to acts 660 and 670. If, however, the member decided to vote for him/herself before the voting has ended, the member may cast a vote [act 620], and any proxy vote cast by the representative will be removed. Thus, a member's vote may “remove/delete” a vote case for him/her by a representative.

Returning to act 620, if the member has not cast a vote, the voting program may check whether the member has appointed a representative to vote on his behalf in such instances [act 650]. If the member has not appointed a representative, the votes available from the member will not be counted for the proposal [act 640].

If the member has appointed a representative, however, the representative may vote for the member [act 660]. The member's vote may be added to any other members who have designated the representative, and the representative's vote may be weighted accordingly. The voting program may treat a representative's vote differently from a regular member's vote. For example, a representative's vote may be published, while a member's vote may remain anonymous. In other implementations, a representative may be prohibited from voting “abstain” when voting for another member. In other implementations, for example, where the vote concerns formation or alteration of the rules governing a business entity, representative voting may not be allowed.

Returning to FIG. 4, a determination is made whether the proposal to form a business entity passes [act 450]. In one implementation, a final pass/fail determination is made at a predetermined time and date specified in the proposal to form the business entity. In another implementation, the final determination may be made at the end of a predetermined or default time period (e.g., two weeks or a month). In still other implementations, once enough votes are garnered for passage, the proposal passes regardless of any remaining time in a voting period. If the proposal to form a business entity fails, the forum 310 returns to normal discussion, adding members, and other business [act 420].

If the proposal passes, a new business entity is established under control of the online forum 310 [act 460]. In one implementation consistent with the principles of the invention, the business entity may be formed automatically (i.e., without further action by the forum 310) upon passage of the proposal. In such a case, the forum 310 may begin to act through the business entity as soon as it is established.

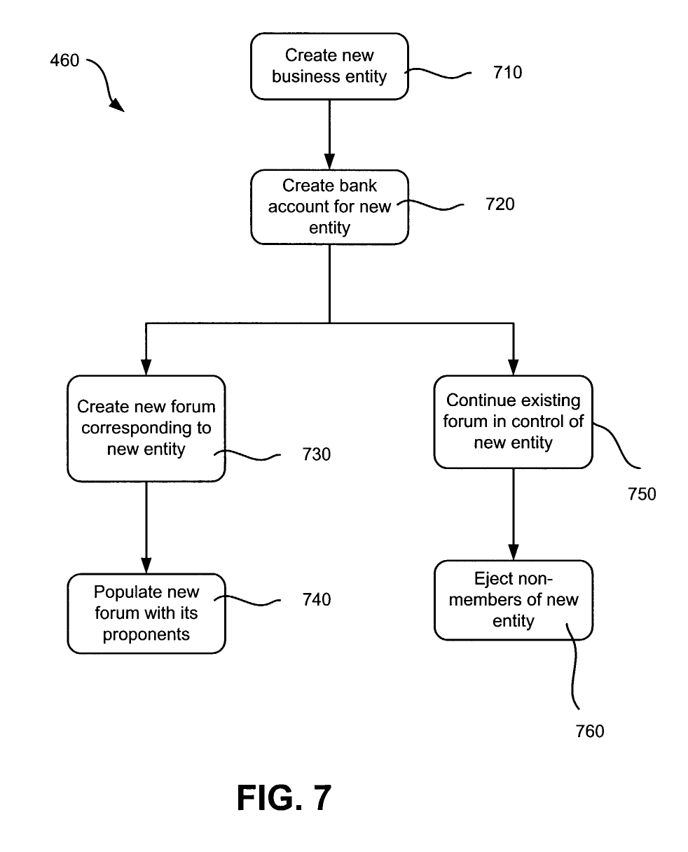

FIG. 7 is a flowchart illustrating an exemplary process for establishing a new business entity (e.g., as part of act 460) in an implementation consistent with the principles of the invention. Upon passage of the proposal, a new business entity may be automatically formed from the forum's perspective [act 710]. Such automatic creation may involve, for example, providing instructions to an agent, and the agent executing the instructions. The instructions may specify the type of business entity, the jurisdiction under which it is to be formed, its by-laws, its officers and/or members, its purpose, and any other information necessary to set up the business entity in the chosen jurisdiction. The instructions may also include any fees (via various online payment schemes, such as PayPal™) necessary for setting up the business entity. The instructions may, for example, be e-mailed directly to a process agent that specializes in setting up business entities.

In one implementation, the instructions may take the form of machine-readable or machine-executable instructions that are transmitted electronically (e.g., via HTML, XML, etc.) and executed by an agent. Various agents (e.g., Business Filings™ Inc., The Company Corporation®, or similar agents) may accept such electronic instructions to form a business entity. The agent may also include an entity (i.e., a “host”) that owns the server 120 and software that facilitates the forum 310. In addition to merely setting up the legal business entity, the agent may perform other tasks typically performed when setting up a business entity, for example obtaining a Taxpayer ID number.

Concurrent with setting up the business entity, a bank account and/or other financial instruments of the business entity may be established [act 720]. As with act 710, the bank account may be automatically established using an electronic, machine implementable instruction to a bank or other financial institution. Once established, fees collected from members of the forum 310 may be sent to the bank account of the business entity.

Controlling the resulting business entity may occur in several ways, depending on a posture of the original forum 310. If, for example, the forum 310 had a general purpose, members of the original forum 310 may wish it to continue. In such an instance, a new forum may be created which corresponds to and controls the new business entity [act 730]. This new forum may be populated by, for example, all members of the original forum 310 that voted to form the new business entity (and/or pledged money toward its creation) [act 740]. Those members of the original forum 310 who abstained from the vote to form the new business entity may, for example, be eligible to join the new forum without a membership application. By contrast, those members who voted against the business entity may need to apply to join the new business entity (e.g., by a process similar to that shown in FIG. 5).

If, for example, the forum 310 was created specifically with the purpose of forming a business entity, the original forum 310 may continue, but in control of the new business entity [act 750]. In such case, members who abstained and members who voted against formation of the new business entity may be ejected from the forum 310 [act 760]. These ejected members may re-join the forum 310, possibly via a membership application as described for act 740.

Returning to FIG. 4, the newly formed business entity may conduct entity business [act 470]. Examples of such business may include buying, selling, payment or receipt of monies, holding meetings, directing individuals (e.g., officers of the entity) to perform certain tasks, etc. The business entity may determine a course of action through discussion, proposals, and voting, as previously described.

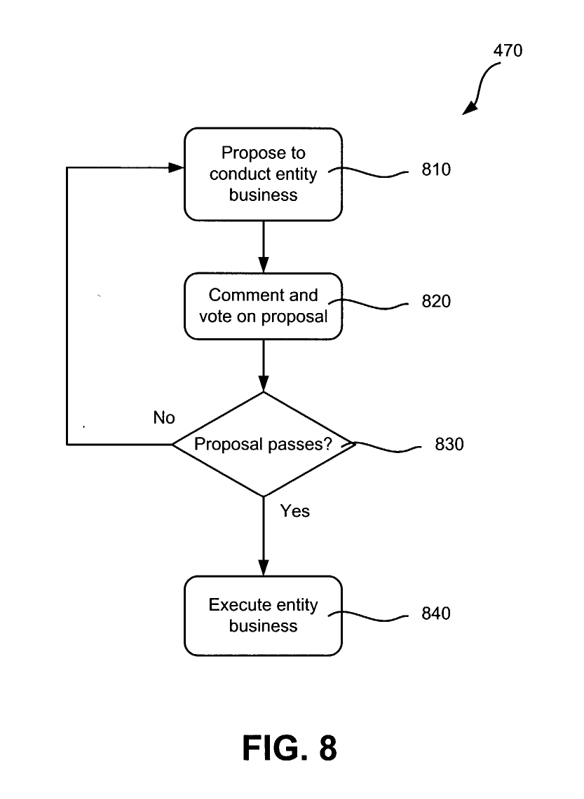

FIG. 8 is a flowchart illustrating an exemplary process for conducting entity business (e.g., as part of act 470) in an implementation consistent with the principles of the invention. A member of the business entity may propose to conduct a certain action as part of ongoing entity business [act 810]. Procedures for proposing a course of action may mirror those discussed above with reference to act 430. In one implementation, a limited class of persons (e.g., officers or committees within the entity) may propose a course of action for the business entity to take. In other implementations, any member of the business entity may make such a proposal.

The proposal may be modified, discussed, and voted upon by members of the entity [act 820]. Procedures for modifying and voting on a proposal may mirror those discussed above with reference to act 440. Unlike the creation of the entity in act 440, however, different vote thresholds may be used. For some entity actions, a quorum may only be required, as opposed to a majority of votes.

A determination is made whether the proposal passes [act 830]. Such a determination may be made by similar methodology to act 450. If the proposal does not pass, the business entity continues as usual, discussing and considering other proposals for action in act 810.

If the proposal passes, the business entity may automatically execute its course of action upon passage [act 840]. Such action may be, for example, directing an individual to perform a certain action, paying a sum of money, entering into a contract, selling or buying products/services, or any number of actions that are typically made by a business entity. As described with respect to act 460, the action may be automatically performed by, for example, sending a computer-readable form or a computer-executable command to an appropriate agent. Action by an officer or employee of the business entity may also be viewed as “automatic” if he acts upon instructions from the business entity without further input from the business entity.

### EXEMPLARY BUSINESS METHOD FOR FACILITATING COLLECTIVE ACTION

An online forum 310 may be hosted on a server 120, which may run software that expedites forum interaction and other activities. The entity that owns the server 120 and maintains any network site(s) that host online forums 310 may be referred to as the “host” of the forum 310. Hosts of forums 310 may perform certain actions (i.e., “hosting”) that allow and facilitate collective action by the forum, for example, as described in FIGS. 4-8. The host may utilize one or more computer programs embodied on computer-readable media to assist it in performing these hosting functions.

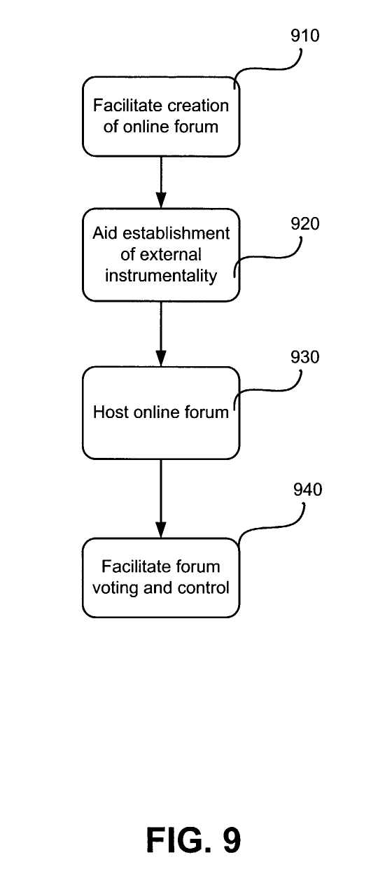

FIG. 9 is a flowchart illustrating an exemplary process for facilitating collective action of an online forum by a host. The process may begin by the host facilitating creation of a new forum [act 910]. The host may receive an application by a “forum creator” requesting creation of a new forum, and may create the forum, perhaps adding it to a list of active forums. In one implementation, the host may announce the formation of the new forum, for example, in a general announcement or administrative forum. In one implementation, as part of the new forum's creation, the host may add the new forum to a public index of active forums, for example, by listing it in an appropriate category within the index. In another possible implementation, if the forum's creator has requested that certain persons be invited to join the new forum, the host may list such persons in an “invited users” list and may send invitations to join to such persons (e.g., by e-mail). The host may also initially set a membership list of the new forum to include the forum's creator.

The process may continue with the host aiding in the establishment of an external instrumentality (e.g., business entity, financial account, etc.) for the new forum [act 920]. For example, if the creator of the new forum has requested that a business entity be associated with the new forum, the host may aid in establishing the business entity. The host may perform the necessary tasks for formation of the business entity, or the host may use an agent for jurisdictions in which it does not customarily assist in forming business entities. The host may store corporate documentation for the online forum, and perhaps may serve as a process agent for the business entity, in accordance with preferences of the forum's creator.

Note that, in contrast to the implementation of FIGS. 4-8, in FIG. 9 the business entity is associated with the online forum before its population with members. Both sequences of events, as well as other sequences of business entity formation, are specifically contemplated as being implementations consistent with the principles of the invention.

In one implementation, if the creator of the new forum has requested, for example, a bank account for the new forum, the host mat provide the creator with a list of financial institutions from which to choose. Upon confirmation of a new account from the institution, the host may store account information (e.g., account number, any authorization codes, balances, etc.) for the online forum. The host may also store an accounts ledger and other financial information for the online forum.

The process may continue with the host performing administrative tasks to host the online forum [act 930]. Such hosting may include adding and logging in members. Adding members may necessitate an additional process of voting by the existing forum membership, as described with respect to FIG. 5. In any event, when a new member is added to the online forum, the host may update a membership list associated with the forum. The host may also notify the jurisdiction of the business entity associated with the forum, if the membership change is required to be reported by the laws or rules of the jurisdiction.

The host may receive and store discussion messages and proposals by members of the online forum as part of its hosting. In this capacity, the host may provide a number of standard commands/proposals that may be used by members of the forum. These commands/proposals may be associated with a user-friendly form (e.g., implemented via HTML, XML, etc.) used to specify associated details. Certain of these commands/proposals may have a human-readable instruction and/or machine-executable code associated with them, to direct the host (or another entity) to perform an action. Examples of such commands/proposals that may be provided by the host for members to use include: invite user; approve/reject membership application; expel member; appoint/remove officer/employee; form business entity; float business entity; dissolve business entity; create account; pay from account; order from account; change entity name; sign contract; instruct officer/employee; create/delete document; modify document; create/delete sub-forum; execute command in sub-forum; delete sub-forum; send comment/proposal to parent forum; apply for forum to join another forum; revoke forum's membership in another forum; send comment/proposal to another forum, etc. Any of these commands/proposals may be made available to members of the forum in, for example, acts 430 or 810.

The host may also facilitate forum voting on proposals, and control of instrumentalities by the online forum [act 940]. In one implementation, the host may track, compute, and report vote totals as described with respect to FIG. 6. When the vote total reaches a passing threshold, the host may send a message to an officer/employee of the business entity if the command/proposal contains human-readable instructions. Similarly, the host may either execute instructions on, for example, server 120 or send such instructions to another machine if the command/proposal contains machine-executable instructions. In some implementations, where officers or employees of the business entity may take some actions without a vote by the online forum, the host may facilitate instructions from the officer/employee.

### CONCLUSION

Methods and systems consistent with the principles of the invention may facilitate the establishment of a business entity or financial instrument to be controlled by an online forum. Members of the online forum may discuss and vote on a proposal to form the business entity, which may be automatically established upon passage of the proposal.

The foregoing description of preferred embodiments of the invention provides illustration and description, but is not intended to be exhaustive or to limit the invention to the precise form disclosed. Modifications and variations will be apparent to those skilled in the art in light of the above teachings or may be acquired from practice of the invention.

For example, although forums are discussed above, the invention is specifically contemplated for use in and by sub-forums. For example, a sub-forum may be created by a larger forum, and may submit proposals to that larger forum. In one implementation, the sub-forum (e.g., a specialized committee) may determine and take action on behalf of a larger forum or on behalf of a traditional non-forum-based entity, such as a conventional company, corporation, etc.

Also, forums may be members of other forums, and the outcome of a vote in one forum may determine how the forum votes as a member of another forum. For example, a business entity (e.g., a company) may be associated with forum A, and forum A may be a member of forum B, which may be associated with a collection of business entities (e.g., an industry association). In such an example, forum B may be controlled by its member forums (e.g., forum A), which may in turn be controlled by votes of their members (e.g., shareholders in the companies). Those skilled in the art will appreciate that there may be multiple levels of membership associated with a given forum (e.g., forums of which the given forum is a member, sub-forums of the given forum, sub-sub forums of the sub-forums, etc.)

In one implementation consistent with the principles of the invention, existing business entities may change their articles to the extent necessary to provide for decision making and governance as described above. Once this occurs, an associated forum may be created, and stockholders/owners/partners of the business entity may be sent login identifiers and passwords to enable their participation in the online forum. Alternately, the forum may have been created in advance of changing the articles to permit discussion of proposed changes.

In other implementations, forums may be established for other purposes than “business.” For example, a forum may be established to shadow and discuss national politics or other topics of general interest. Votes may be taken on issues raised by members of the forum (or a creator/moderator) in accordance with the voting method described in FIG. 6.

Although implementations above describe creating, viewing, editing, and amending proposals, implementations consistent with the principles of the invention may be used for any type of collaborative document generation. For example, the online forum may collectively author a text or multimedia document that may be, for example, represented in XML during discussion and editing. Another implementation involves collective programming. For example, text-based computer programs may be converted to XML for collaborative programming. The collaboratively generated programs may be in one of a number of languages, such as Java, C, C++, Perl, Prolog, etc.

Although presented above in the context of business entities, implementations consistent with the principles of the invention may execute any type of machine-executable code or programs upon a collective decision to do so by an online forum. For example, any type of service or sale may be automatically initiated by a vote in conjunction with a machine-executable command that is executed when the voting reaches a threshold. Also, entry points or inputs to the machine-executable command may come from external to the online forum, for example an e-mail message or am HTTP request. The machine-executable code or program need not be self-contained, but may receive inputs from other sources if appropriate.

Other details of administering an online forum will become apparent to those skilled in the art. For example, the site hosting the forum (or the forum itself) may provide an ability for members to filter submissions and proposals in the forum for easier viewing. The submissions may be filtered by time, representatives, members, and censure lists. Censure lists may be maintained for members, the forum, or both to list members that generate troublesome, abusive, irrelevant, or otherwise ill-accepted comments or proposals. Such lists may be maintained by proposals and voting, as described above. Further, the site (or the forum itself) may have associated legal and secretarial services to aid in establishing the instrumentalities previously mentioned. Such services may also aid in communications between forum-controlled business entities and entities external to the site or forum. For example, the site (or the forum itself) may e-mail directions or requests on behalf of an online forum via such services when requested to do so by that forum.

Moreover, the acts in FIGS. 4-9 need not be implemented in the order shown; nor do all of the acts need to be performed. Also, those acts which are not dependent on other acts may be performed in parallel with the other acts.

No element, act, or instruction used in the description of the present application should be construed as critical or essential to the invention unless explicitly described as such. Also, as used herein, the article “a” is intended to include one or more items. Where only one item is intended, the term “one” or similar language is used.

The scope of the invention is defined by the claims and their equivalents.

What is claimed is

1. A method for establishing a business entity by an online forum, comprising:
proposing to form a business entity;
reviewing, within the online forum, a proposal associated with forming the business entity;
voting on the proposal by members of the online forum; and
establishing the business entity if a sufficient number of members of the online forum vote for the proposal.

2. The method of claim 1, further comprising:
creating the online forum; and
populating the online forum with a plurality of members.

3. The method of claim 2, wherein the populating includes:
applying for membership in the online forum using an application; and
adding a new member to the online forum if the application meets membership criteria.

4. The method of claim 2, wherein the populating includes:
inviting a prospective member to join the online forum using an invitation; and
adding the prospective member to the online forum if the invitation is accepted.

5. The method of claim 1, wherein the proposing includes:
specifying a type of business entity to be formed and a jurisdiction under whose laws the business entity will function.

6. The method of claim 5, wherein the proposing further includes:
defining an ownership structure for the business entity.

7. The method of claim 1, wherein the reviewing includes:
introducing an amendment to the proposal.

8. The method of claim 1, wherein the voting includes:
designating a representative to vote for a member in an absence of a vote cast by the member.

9. The method of claim 1, wherein the voting includes:
casting a vote to abstain from voting on the proposal.

10. The method of claim 1, wherein the establishing includes:
automatically delivering human-readable or machine-executable instructions to an agent or processing device for establishing the business entity upon passage of the proposal.

11. The method of claim 10, wherein the establishing includes:
automatically sending human-readable or machine-executable instructions to a financial institution for opening a financial account upon passage of the proposal.

12. The method of claim 10, wherein the establishing includes:
creating a new online forum corresponding to the business entity; and
populating the new online forum with selected members from the online forum in which the proposal was voted on.

13. The method of claim 10, wherein the establishing includes:
continuing the online forum to control the business entity; and
ejecting members of the online forum that are not associated with the business entity.

14. The method of claim 1, further comprising:
controlling the business entity by the online forum.

15. A method for facilitating collective action by an online forum, comprising:
aiding in creation of the online forum;
assisting in establishment of an external instrumentality to be controlled by the online forum;
hosting the online forum; and
facilitating determination of a collective will of the online forum.

16. The method of claim 15, wherein the aiding includes:
creating the online forum in response to a request, including generating appropriate database entries corresponding to the online forum.

17. The method of claim 15, wherein the aiding includes:
announcing an existence of the online forum in an announcement forum.

18. The method of claim 15, wherein the aiding includes:
adding the online forum to an index of online forums.

19. The method of claim 15, wherein the aiding includes:
inviting a list of users to join the online forum.

20. The method of claim 15, wherein the external instrumentality includes a business entity, and
wherein the assisting includes:
setting up the business entity in an appropriate jurisdiction with articles specifying that the business entity will be governed by the online forum.

21. The method of claim 20, wherein the setting up includes:
directing an agent to establish the business entity in the appropriate jurisdiction.

22. The method of claim 15, wherein the external instrumentality includes a financial account, and
wherein the assisting includes:
setting up the financial account with a financial institution on behalf of the online forum.

23. The method of claim 22, wherein the setting up includes:
storing information associated with the financial account.

24. The method of claim 15, wherein the hosting includes:
admitting new members to the forum if the new members meet membership criteria.

25. The method of claim 15, wherein the hosting includes:
storing documents associated with the online forum, at least one of the documents containing machine-executable program code.

26. The method of claim 25, wherein the hosting further includes:
providing a list of commands from which a member of the online forum may choose when creating or modifying a proposal for action by the online forum.

27. The method of claim 26, wherein at least one of the list of commands includes human-readable instructions.

28. The method of claim 15, wherein the facilitating includes:
tallying votes cast by members relating to a proposal for action by the online forum, and
determining that the proposal passes based on predetermined voting criteria.

29. The method of claim 28, further comprising:
delivering human-readable or machine-executable instructions to a recipient human or machine for execution upon passage of the proposal.

30. A method for facilitating collective action by an online forum, comprising:
storing a machine-executable command proposed by a member of the online forum;
counting votes of members of the online forum regarding the machine-executable command; and
facilitating execution of the machine-executable command when a threshold number of votes in favor of the machine-executable command are counted.

31. The method of claim 30, wherein the machine-executable command is a request to establish a particular type of business entity.

32. The method of claim 30, wherein the machine-executable command is a request to establish a financial instrument or enter into a contract.

33. The method of claim 30, wherein the facilitating includes:
sending the machine-executable command to an appropriate machine for execution.

34. The method of claim 30, wherein the facilitating includes:
executing the machine-executable command using an input obtained from a source external to the online forum.

35. The method of claim 30, wherein the counting includes:
weighting the votes of the members according to fees paid by the members or ownership stakes of the members.

36. A method for collective action by an online forum, comprising:
proposing execution of a machine-executable command to the online forum by a member of the online forum;
voting, by members of the online forum, whether to execute the machine-executable command; and
transmitting the machine-executable command for execution in response to the voting and based on predetermined voting criteria.

37. The method of claim 36, wherein the voting includes:
casting a member's vote by a representative when the member does not cast the vote.

38. A computer-readable medium that stores instructions executable by one or more processors to perform a method for facilitating collective action by an online forum, comprising:
instructions for creating a new online forum in response to a request;
instructions for setting up a business entity in an appropriate jurisdiction with articles specifying that the business entity will be controlled by the online forum;
instructions for storing proposals for action by the online forum, at least one proposal being for setting up the business entity; and
instructions for establishing voting procedures by the online forum on the proposal for setting up the business entity.

39. A method, comprising:
amending articles of an existing business entity to permit governance of the existing business entity by an online forum;
creating the online forum;
assigning shareholders of the existing business entity respective memberships in the online forum; and
governing the existing business entity by the online forum.

40. A method, comprising:
hosting an online forum;
storing a proposal; and
facilitating voting on the proposal by members of the online forum including providing a mechanism for members of the online forum to designate respective representatives to vote for the members when the members do not cast votes.
